(19) United States
(12) Patent Application Publication
(10) Pub. No.: US 2024/0421995 A1
(43) Pub. Date: Dec. 19, 2024

(54) SYSTEMS AND METHODS FOR PROVIDING BLOCK-CHAIN BASED DUAL ASSET COMPRISING A PHYSICAL AND NON-FUNGIBLE ITEM

(71) Applicant: Dan Rosado, North Richland Hills, TX (US)

(72) Inventor: Dan Rosado, North Richland Hills, TX (US)

(21) Appl. No.: 18/336,615

(22) Filed: Jun. 16, 2023

(51) Int. Cl. H04L 9/32; G06K 19/06

(52) U.S. Cl. CPC H04L 9/3213; G06K 19/06037; H04L 9/3247; H04L 2209/60

(57) ABSTRACT

A system and method for providing a dual asset comprising a physical token having a physical identifier, like a QR code or SnapRing manufactured in the token itself and non-fungible token associated with the physical identifier and stored in at least one block of a block chain, wherein the block chain is secured by the physical token and vice versa.

### BACKGROUND

### 1. Field of the Disclosure

The present invention relates to systems and methods for providing authentication for one-of-a kind physical articles, as well as incorporated associated security measures and identity verification.

### 2. Background of the Disclosure

Manufacturers of quality, unique one-of-a-kind products, such as coins or trading cards, are plagued by the sale of counterfeit products. Imitation goods are made with the intent to deceive buyers into believing that they are purchasing the manufacturers true and authentic goods. Unauthorized production and counterfeit reproduction of goods will erode the brand's value and exclusivity, negatively affect profitability, and may compromise a consumer's perception of the product as “collectable.”

In the digital realm, supply may not be constrained by the original developer; a subsequent party may duplicate the original digital model. Therefore, a counterfeit digital product may exist thereby eroding the value of the original collectable item.

Typically, when a unique physical object is converted to a digital asset (a Non-Fungible Token or “NFT”) there is not a system to authenticate, couple, and activate the original physical object with the NFT produced from that object. However, a digital asset or NFT built on a block chain has authentication built in as part of the process. Each digital asset contains a Content Identifier (CID), a label formed using a string of letters and numbers to represent it. It is a part of that asset's smart contract. Smart contracts are used for NFTs' minting process (creation) and to assign ownership of the token. When a new non-fungible token is minted, the smart contract automatically sets the creator as the owner. NFT smart contracts can transfer the token to new owners when a sale is made.

Currently, a physical asset may have an ID mechanism placed on the object following the manufacturing process. Within this process two possibilities arise: 1) the ID mechanism is removable, and 2) the value of the physical object may diminish. Potentially, the intrinsic value of both the physical and any related digital objects may decrease.

### SUMMARY OF THE INVENTION

The invention is a system designed to allow a physical object (e.g., a custom coin, trading card, or other physical one-of-a-kind object) to be embedded/produced with step one of a physical ID (PID) process such that the PID is a part of the coin and is not removable, such as through stamping or engraving, machining, forging, etc. The invention allows a consumer to purchase the physical and digital products as one entity. In a two-step transaction, the physical coin is produced (with the PID), and the NFT is subsequently created from that physical coin. Upon receipt of the physical coin, the owner will authenticate and link the NFT, thereby confirming the authenticity of both the physical and digital asset. Authentication occurs via an online confirmation for which the only purchasing consumer has access. The authentication completes the transaction, the process is recorded in the smart contract, and the intrinsic value of the linked assets is increased.

### BRIEF DESCRIPTION OF THE DRAWINGS

FIG. 1 illustrates front and back views of a coin manufactured in accordance with the principles of the present disclosure;

FIG. 2 illustrates a perspective view of a coin manufactured in accordance with the principles of the present disclosure;

FIG. 3 illustrates front and back views of a trading card manufactured in accordance with the principles of the present disclosure;

FIG. 4 illustrates front and back views of a credit card manufactured in accordance with the principles of the present disclosure; and

FIG. 5 illustrates a method of creating a one-of-a-kind physical object with a corresponding non-fungible token in accordance with principles of the present disclosure.

### DETAILED DESCRIPTION OF THE INVENTION

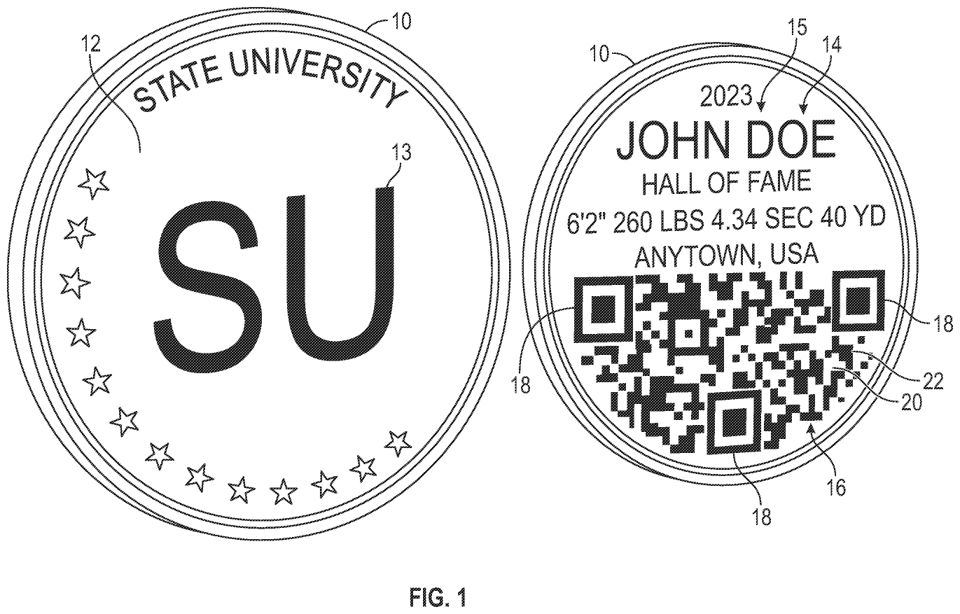

The present invention for the creation of a dual asset is best described with referenced to the attached figures. In terms of the present invention, the term “dual asset” is used to identify a physical object that has a corresponding non-fungible token (“NFT”) associated with it, so that the physical item is specifically linked to its digital counterpart. For example, FIG. 1 illustrates a coin 10 manufactured in accordance with the present disclosure. Coin 10 may include a design, logo, or other information 13 on the front 12. Coin 10 also has a rear 14, which may include additional information, such as personalized or unique information 15. As will be readily understood, the information on the front 12 and rear 14 may be interchangeable so that standard information, such as a college or university, organization, professional or amateur sports team, club, military unit identifier, or other standard information may be included on either front 12 or rear 14 of coin 10, or both. On either the front 12 or rear 14 (shown), a physical identification (PID) 16 may be included. In the example shown, the PID 16 is an example of a quick response (“QR”) code. In the embodiment shown, the coin 10 is made of a metal alloy, but may also be manufactured from a substance suitable for engraving, embossing, etching, stamping, machining, forging, or molding, such as, for example metal, metal alloy, carbon, fiberglass, carbon fiber, plastic, wood, glass, or silicon. In the example shown, the QR code is manufactured as a part of the coin itself, and includes reference squares 18, ridges 20 and relief 22. Manufactured in this manner, the PID 16 is manufactured as an integral part of the coin itself, and is readable in a similar manner as by a phone camera, scanner, or other device that can discern the differences in the information contained in the PID 16. Other examples of PID 16 include bar codes, snap tags, and other visual information prompts, as are known in the art.

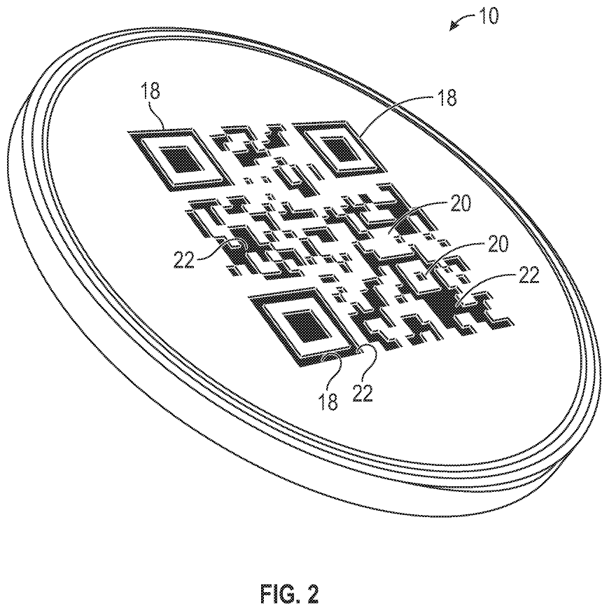

FIG. 2 shows a perspective view of a coin 10, that shows the PID 16 in the form of an engraved QR code. In the engraved version shown in FIG. 2, the reference squares, ridges, and valleys are not painted or printed, and are therefore a permanent identifier of the information necessary to verify the authenticity of the coin 10.

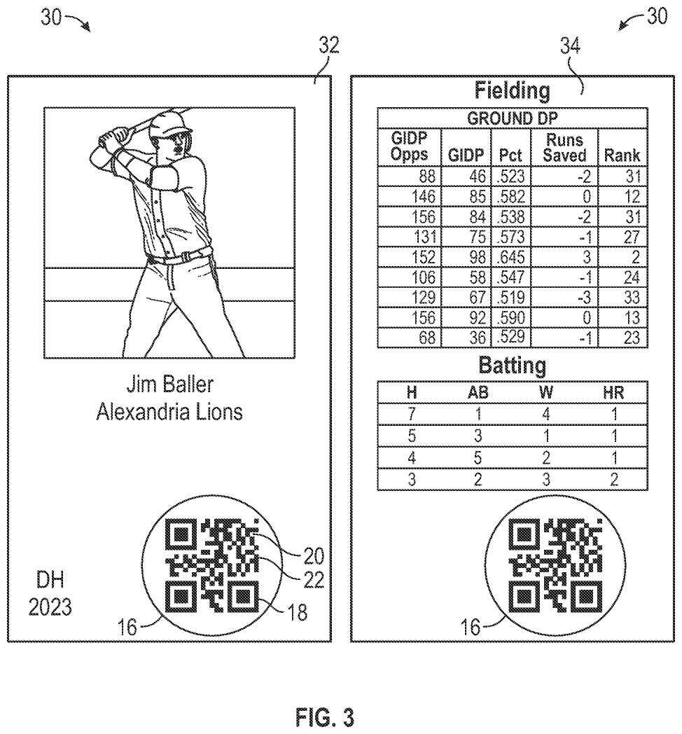

FIG. 3 shows a generic baseball card 30 including the principles of the present disclosure. Card 30 has a front 32 that may include a name, team (or team logo), or other identifying information. Rear 34 of card 30 may include other identifying information, including performance metrics, prior season metrics, and, if the card is a “limited edition,” or other unique card identifier, such as the number of the card in a limited series, such as 001/300 for the first card in a limited run of 300 similar cards. Regardless, each card may be identified and/or authenticated using the principles of this disclosure, including use of a PID 16 on either front 32 or rear 34 of card 30. Additionally, card 30 under the present disclosure is preferably manufactured using a rigid material, such as metal, metal alloy, carbon, fiberglass, carbon fiber, plastic, wood, glass, or silicon, or other suitable rigid material, and may be manufactured using a mold, forging process, machining, engraving, or other suitable methods in the same manner as with coin 10 of FIGS. 1 & 2.

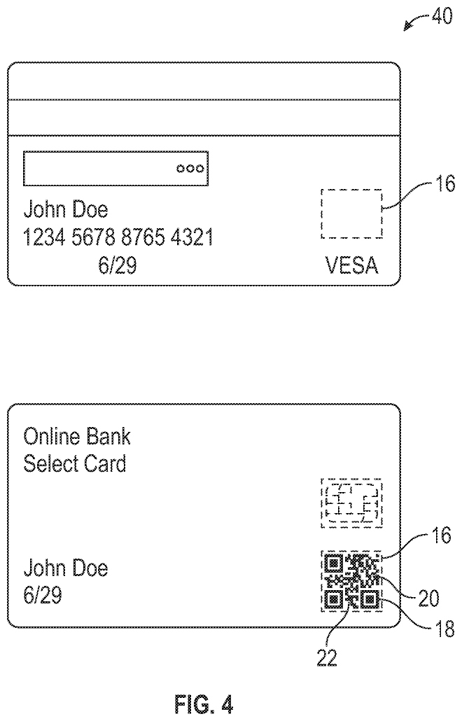

FIG. 4 shows a credit card 40 manufactured in accordance with the principles of the present disclosure. In lieu of an EMV chip, a PID 16, such as a QR code may be included in the card. In such a case, a card reader would simply need to visually scan the PID 16 to determine the authenticity of the card in accordance with the principles of the disclosure, as further described below.

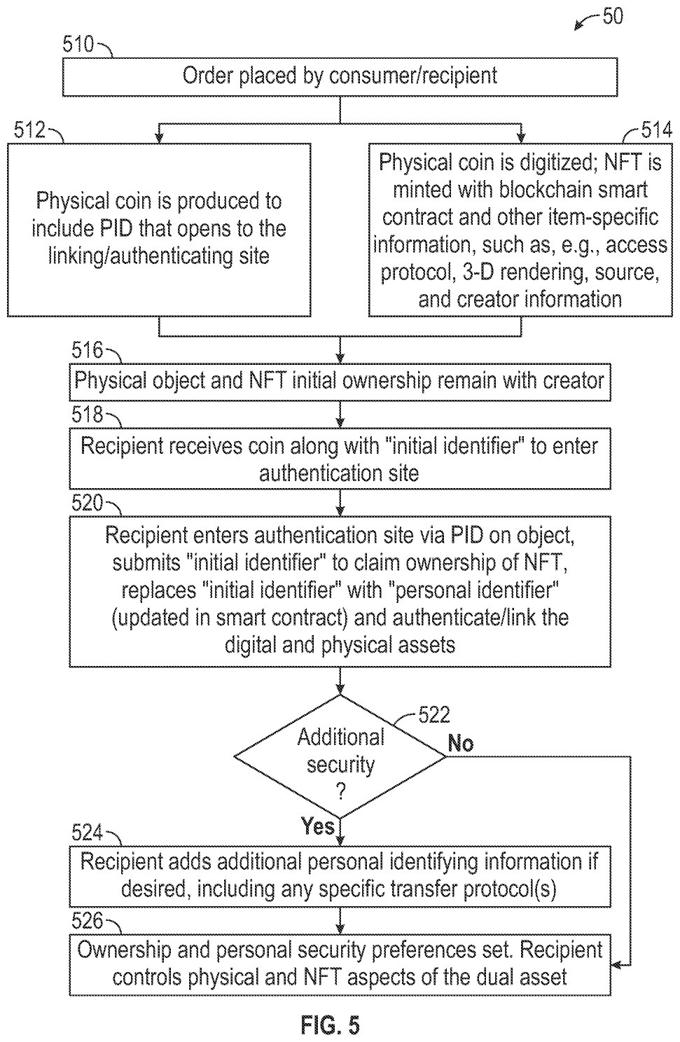

FIG. 5 shows the steps of the creation of the unique dual asset in accordance with the present disclosure. At step 510, an order for a is placed by a consumer, or recipient. An example would be a commemorative coin, such as for retirement from a prestigious organization, military, change of command in the military, or the like. Alternatively, the order could be for a trading card or credit card company, where a large number of similar items may be manufactured, although with each having a unique PID. Examples of this may be coins for a national- or league championship team, where each coin or item includes the same information, but each is uniquely identified using its PID.

After an order is made, either simultaneously with the manufacture of the physical item at step 512, or soon before or after the manufacture, the physical item may be digitized at step 514, such as using a three-dimensional rendering or other technology that allows a recipient to access a virtual version of the physical asset, whether for advertising or to maintain the physical security of the physical portion of the dual asset (such as in a safe deposit box or other secure location/facility). Also at step 514, the PID assigned to be physically engraved, embedded, stamped, or forged into the surface of the physical item, such as a coin or card, the PID is associated with a block in a block chain. The block chain used may be any of the block chain protocols available for use, such as Bitcoin protocol, Ehtereum protocol, and/or other protocols related to digital currencies and/or block chains. Preferably, the block of the block chain includes a three-dimensional rendering of the physical item, security authentication information, such as an initial identifier, to allow initial access to an eventual recipient, source/creator information, and other information requested by the consumer/recipient at order. In the case of a credit card, the block associated with the NFT may also include bank account/credit account information and consumer-specific information necessary for financial transactions.

After steps 512 and 514, the ownership and/or control of the item remains with the creator at step 516. At step 518, a recipient receives the physical item, such as coin 10, sports card 30, or credit card 40 and the “initial identifier.” To claim ownership of the item, the recipient need only use a smart phone camera, computer, or other provided initial identifier information to access the block of the block chain where the NFT data resides. When prompted, at step 520, the recipient can enter a personal identification number (PIN), password, biometric information (such as voice, retinal scan, fingerprint, or other biometric information) to personalize the security of the NFT, and by extension, the ownership of the physical version of the dual asset. Depending on the type of item, at step 522, the recipient (new owner) of the item may decide to enter other required information. For example, if the item is a credit card, the recipient may desire to enter transaction specific information, such as a signature or biometric data, at step 524. This type of addition has the added advantage of allowing an authentication system at a point-of-sale (POS) terminal to compare the signature stored in the block of the block chain containing the NFT against a signature supplied at the POS terminal. After initial authorization and personalization at step 520, or the election at step 524 to add additional security/authentication information, the recipient's ownership and security preferences are established at step 526, and the recipient controls both the physical and NFT aspects of the dual asset.

The present systems and methods include other advantages. These advantages include, but are not limited to, the recipient may set the number and type of authenticators required to allow transfer of the asset to another individual—for example in case of a sale of the asset to another individual; in the event the physical copy of the item is lost or stolen, the original PID (QR Code or SnapRing, etc.) may be associated with the original, which may be labeled as “non-authentic,” or in the case of a credit card, to deactivate the card for future transactions. In such a case, depending on the type of item, a replacement physical item with a different PID could be created with a new block hashed from the original block with the recipient/owner's permission.

Other advantages will be apparent to those of skill in the art.

What is claimed is:

1. A dual asset comprising:
a physical token including a physical identifier; and
a non-fungible token stored in at least one unique block of a block chain;
wherein physical identifier is integral to the physical token, the non-fungible token is unique to the integral physical identifier, and wherein the block of the block chain is accessible via one or more hardware processors configured by machine readable instructions to store information specific to the physical token and non-fungible token, including the physical identifier and an access code.

2. The dual asset of claim 1, wherein the physical token comprises a coin.

3. The dual asset of claim 1, wherein the physical token comprises a trading card.

4. The dual asset of claim 1, wherein the physical token comprises a credit card.

5. The dual asset of claim 1, wherein the physical identifier comprises an optical code engraved into a surface of the physical token;

6. The dual asset of claim 1, wherein the physical identifier is etched into a surface of the physical token.

7. The dual asset of claim 1, wherein non-fungible token further comprises a three-dimensional rendering of the physical token stored in the block of the block chain.

8. The dual asset of claim 1, wherein the non-fungible token further comprises a unique access code associated with the physical identifier to allow access to the non-fungible token for personalization of the token by a recipient of the dual asset.

9. The dual asset of claim 1, wherein the physical token is manufactured from one of a group consisting of metal, metal alloy, carbon, fiberglass, carbon fiber, plastic, wood, glass, and silicon.

10. The dual asset of claim 8, wherein the non-fungible token further comprises accessibility through the hardware processors to personally configure access security to the non-fungible token.

11. A method for creating a personalized dual asset comprising:
receiving a request for the creation of a dual asset;
manufacturing a physical token comprising a physical identification integral to the physical item, wherein the physical identification comprises information sufficient to direct a recipient to an internet site providing access to a block of a block chain;
digitizing the physical item and storing as a non-fungible token in the block of the block chain associated with the physical identification on the physical token;
providing a recipient of the dual asset with an initial identifier that permits access to the block of the block chain associated with the physical token.

12. The method of claim 11, further comprising;
providing personalization options to the recipient in the block of the block chain, the personalization options operable to permit the recipient of the dual asset to change the initial identifier into a personal identifier.

13. The method of claim 12, further comprising;
providing a personal security option to the recipient in the block of the block chain, the personal security option operable to permit the recipient of the dual asset to provide secure access to the non-fungible token.

14. The method of claim 13, wherein the personal security option comprises a password to access the non-fungible token.

15. The method of claim 13, wherein the personal security option comprises providing a digitally stored signature of the recipient to compare against an access attempt.

16. The method of claim 13, wherein the personal security option comprises presenting both the physical identifier of the physical token and the personal security option to authenticate the dual asset.
